(19) United States
(12) Patent Application Publication
(10) Pub. No.: US 2013/0025060 A1
(43) Pub. Date: Jan. 31, 2013

(54) POCKET HAND PILLOW AND METHODS OF MANUFACTURING SAME

(71) Applicants: James Troy Shull, Plano, TX (US); Matthew Curry Shull, Frisco, TX (US)

(72) Inventors: James Troy Shull, Plano, TX (US); Matthew Curry Shull, Frisco, TX (US)

(73) Assignee: BEAR IN MIND COMPANY, Austin, TX (US)

(21) Appl. No.: 13/190,088

(22) Filed: Jul. 25, 2011

(51) Int. Cl. A47G 9/10; D05B 97/00; B23P 17/04

(52) U.S. Cl. 5/646; 29/428; 112/475.01

(57) ABSTRACT

Disclosed herein are embodiments of a pillow with a pocket in which the hand can be inserted into the pocket, as well as related methods of manufacturing such a pillow. In embodiment, such a pillow may comprise a first side of said pillow, where the first side comprises a first outer layer and a first inner layer, and a first filling material located between the first outer and inner layers. In such an embodiment, the pillow may also comprise a second side having a second outer layer and a second inner layer, and having a second filling material located between the second outer and inner layers. Moreover, in such embodiments, said first side and said second side are attached to each other along at least a portion of their corresponding edges to create a pocket between the first and second sides. With the addition of a pocket, the pillow does not slide off or roll off the person's hand when resting or sleeping.

### TECHNICAL FIELD

The present disclosure relates generally to pillows, and more specifically to a hand pillow.

### BACKGROUND

Pillows come in all shapes and sizes. They are primarily used on a bed when sleeping but may also be used as accents on a bed or couch. However, when one is traveling in a car or on an airplane, for example, it may not be convenient or desirable to bring a pillow. Furthermore, a pillow may be offered by the airlines; however, a person may not want to use a pillow that has been used by other passengers.

A pillow insert is comprised of an outer shell and fill material. The outer shell is typically comprised of material such as polyester or cotton. The fill material, which is also referred to as the stuffing, may be feathers, down, foam, recycled polyester, virgin polyester, or some other natural/synthetic materials.

The pillow insert is usually placed inside of a pillow case, which could be plain or decorative. The pillow case could be open on one end so that the user could remove the pillow insert, or the pillow case could be stitched closed as in the case of most accent pillows. Besides leaving the end open or stitching it closed, the manufacturer may also choose to finish the pillow by adding a zipper, buttons, or a flap.

Most pillows are too large to carry when traveling, or the users may not have the space to carry the pillow among their travel belongings. More importantly, the user usually does not have the room to lie down in a car or on a plane when traveling. A person may place a pillow in between the head and palm of the hand. However, this pillow may be oversized and is not suited for placing on the palm of the hand. As a result, the pillow may slide off the person's hand when sleeping simply because it is not properly sized and not suitable for such an application.

### SUMMARY

Rather than use a standard pillow, the principles of the present disclosure allow the use of a pillow with a pocket in which the hand can be inserted into the pocket. The pillow has been resized to substantially accommodate a person's hand. With the addition of a pocket, the pillow does not slide off or roll off the person's hand when resting or sleeping.

In one aspect, a pillow having a pocket is provided, and in one embodiment, such a pillow may comprise a first side of said pillow, where the first side comprises a first outer layer and a first inner layer, and a first filling material located between the first outer and inner layers. In such an embodiment, the pillow may also comprise a second side having a second outer layer and a second inner layer, and having a second filling material located between the second outer and inner layers. Moreover, in such embodiments, said first side and said second side are attached to each other along at least a portion of their corresponding edges to create a pocket between the first and second sides.

In another embodiment of a pillow having a pocket, the pillow may comprise a first side having a first outer layer and a first inner layer, and having a first filling material located between the first outer and inner layers. In addition, this embodiment of a pillow may then simply have a second side, wherein said first side and said second side are attached to each other along at least a portion of their corresponding edges to create a pocket between the first and second sides.

In another aspect, methods of manufacturing pillows having a pocket therein are also disclosed herein. In one embodiment, such a method may comprise combining a first outer layer and a first inner layer, and having a first filling material located between the first outer and inner layers, to create a first side of said pillow. In such an embodiment, the method may also include providing a second side of said pillow, and then creating a pocket between the first and second sides by attaching said first side and said second side along at least a portion of their corresponding edges.

In sum, a pocket-containing hand pillow in accordance with the present disclosure is more suitable than a traditional pillow when the person does not have the luxury or space to lay down (e.g., as in a bed). Furthermore, a pocket hand pillow can be substantially smaller in size than a traditional pillow and could be placed in a hand bag, briefcase, pack back, purse, or computer bag when traveling.

### BRIEF DESCRIPTION OF THE DRAWINGS

FIG. 1 illustrates one embodiment of a hand pillow according to the disclosed principles, which is comprised of four layers, each with substantially the same lengths and widths;

FIG. 2a illustrates the four layers of the hand pillow illustrated in FIG. 1, which are attached along two and/or four edges to form a hand pillow constructed according to the disclosed principles;

FIG. 2b illustrates a front view of pocket of the hand pillow of FIG. 1;

FIG. 2c illustrates a side view of the hand pillow of FIG. 1;

FIG. 2d illustrates a hand that has been inserted into the pocket of the hand pillow of FIG. 1;

FIG. 3 illustrates another embodiment of a hand pillow according to the disclosed principles, which is comprised of three layers, each with substantially the same lengths and widths;

FIG. 4 illustrates the four layers of the hand pillow illustrated in FIG. 3, which are attached along two and/or four edges to form a hand pillow constructed according to the disclosed principles;

### DETAILED DESCRIPTION

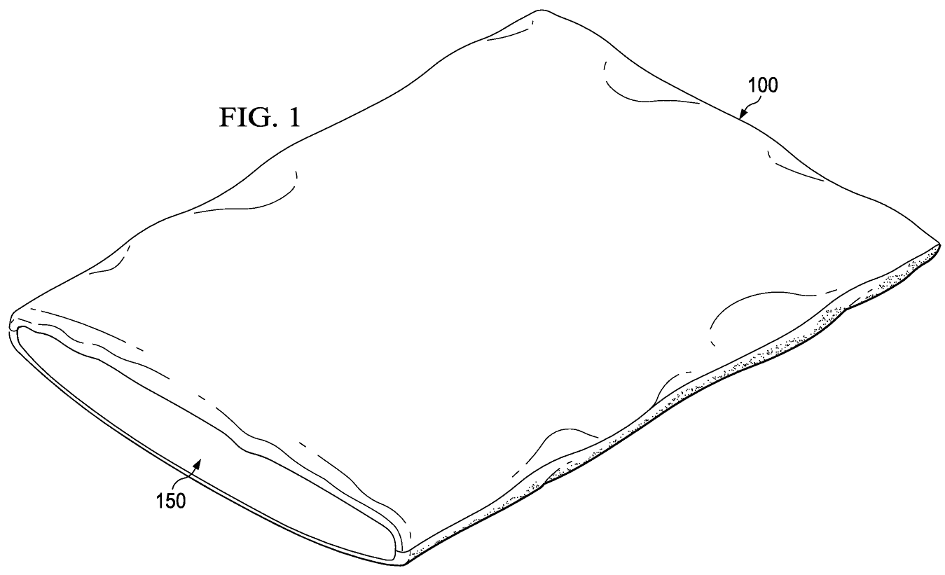

FIG. 1 illustrates an exemplary embodiment for a hand pillow 100 constructed according to the disclosed principles.

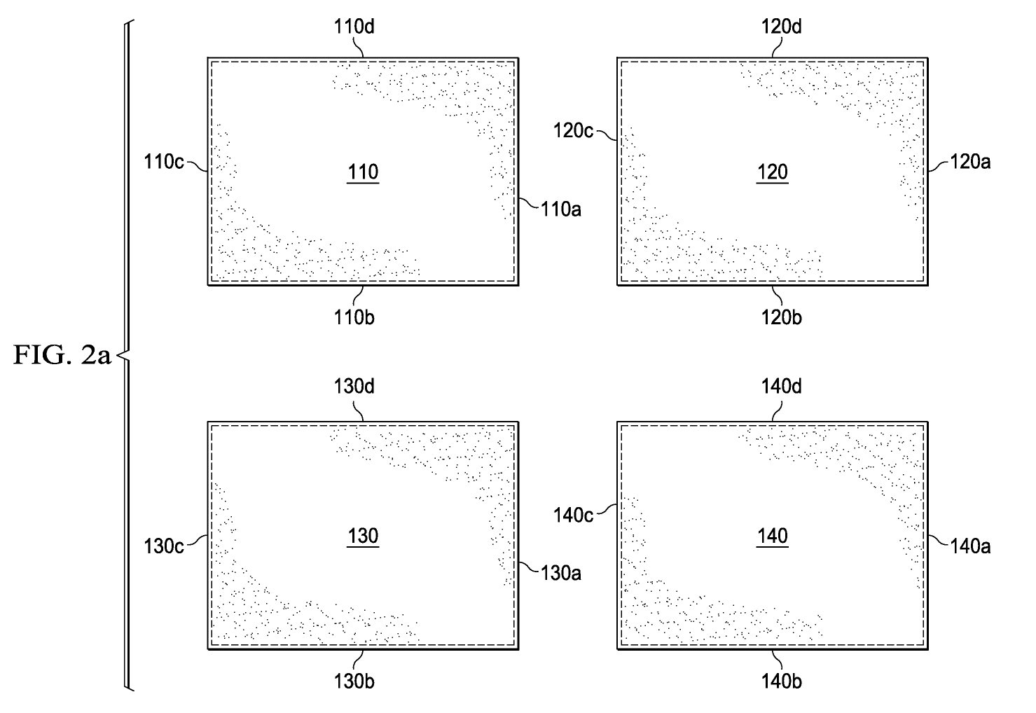

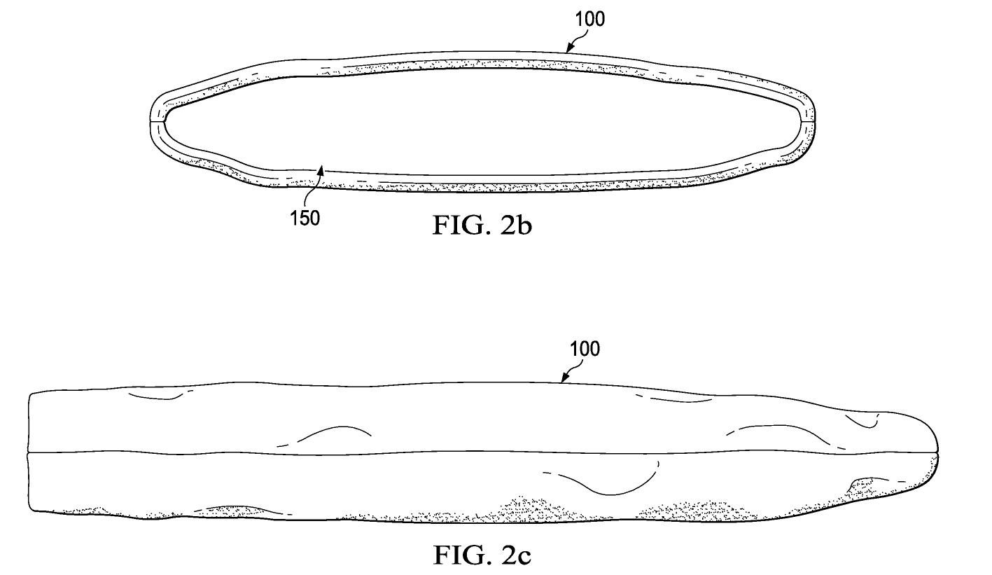

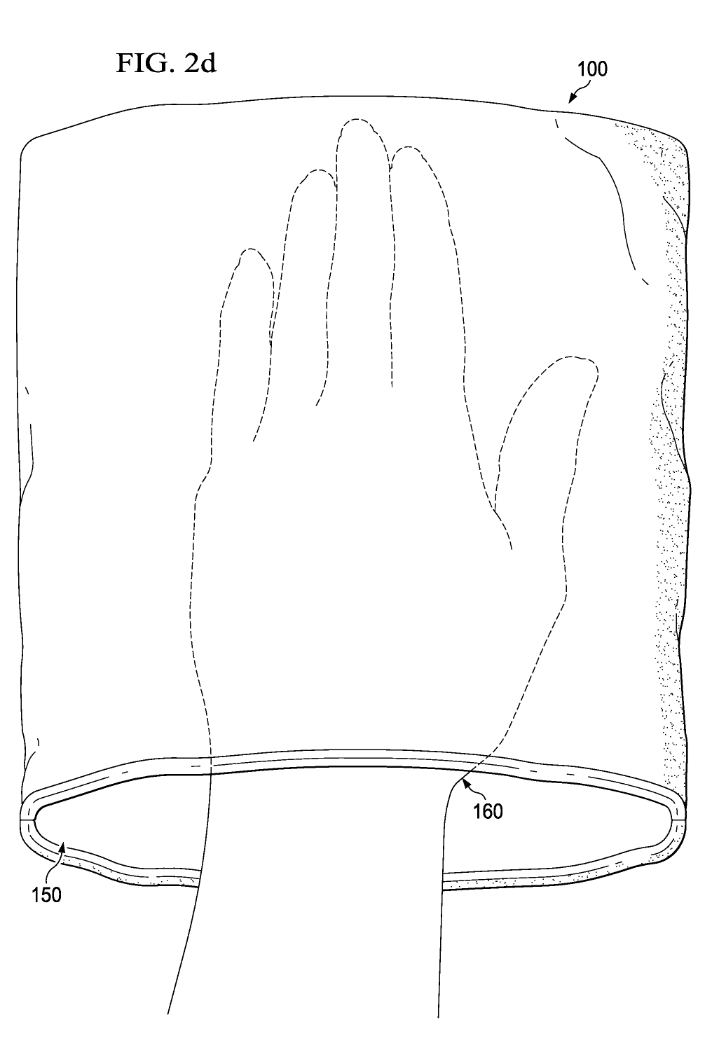

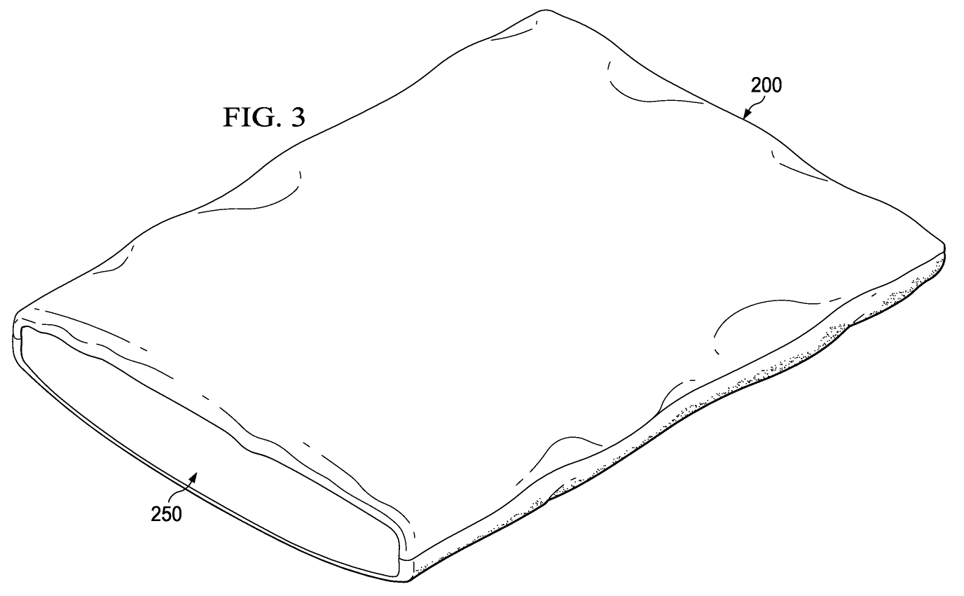

FIG. 2a illustrates items of hand pillow 100 in this embodiment, with different layers:
Layer 110
Layer 120
Layer 130
Layer 140
   Hand pillow 100 is comprised of layers 110, 120, 130, and 140, each of which has substantially the same dimensions along their widths and lengths, as illustrated in FIG. 2a. In addition, in this embodiment, layer 110 has four sides or edges (110a, 110b, 110c and 110d), layer 120 has four sides or edges (120a, 120b, 120c and 120d), layer 130 has four sides or edges (130a, 130b, 130c and 130d), and layer 140 has four sides or edges (140a, 140b, 140c and 140d). Each of the layers 110, 120, 130, 140, 150, 160 having four sides is merely illustrative, and thus layers have any number of sides, no sides per se such as with round- or elliptical-shaped hand pillows, or even pillows substantially shaped like the outline of a user's hand, are also envisioned and fall within the scope of the present disclosure.

A fill material such as polyester, down, or feathers may be placed between layers 110 and 120 or 130 and 140. Another option may be to put fill material between layers 110 and 120 and between 130 and 140. A manufacturer may also choose to use a pillow insert, in which case the pillow insert would be placed between layers 110 and 120 or 130 and 140. The manufacturer may also have pillow insert between 110 and 120 and another pillow insert between 130 and 140.

FIG. 2a illustrates the individual layers 110, 120, 130, and 140 and the exemplary areas of attachment. The “X” represents the area of attachment. FIG. 2a shows the area of attachment substantially along certain edges of the pillow 100. Specifically, sides 110a, 120a, 130a, and 140a are attached together. Sides 110b and 120b are attached together in order to keep the fill material within layers 110 and 120. If a pillow insert is used, then sides 110b and 120b may, but are not required to, be attached together. Sides 130b and 140b are attached together. Sides 110c, 120c, 130c, and 140c are attached together. Sides 110d, 120d, 130d, and 140d are attached together. Attaching the layers as described above creates a pocket 150.

FIGS. 2b and 2c illustrate a front view and side view of the hand pillow 100, respectively. FIG. 2d illustrates a hand 160 that has been inserted into pocket 150 of the hand pillow 100. The palm of the person's hand 160 is substantially in contact with the bottom side of layer 120. The person's face would be substantially in contact with the top side of layer 110.

The attached edges substantially prevent the hand pillow 100 from sliding off the person's hand 150. The preferable method of attachment along the appropriate edges is sewing, although other methods to secure the layers together could also be used. A traditional pillow does not have a pocket and may slide off its resting place when the person is resting.

Of course, the above description of the embodiment illustrated in FIG. 1 is illustrative only, and variations to the above-described approach may also be included in a hand pillow constructed according to the disclosed principles.

FIG. 3 illustrates another exemplary embodiment for a hand pillow 200 constructed according to the disclosed principles.

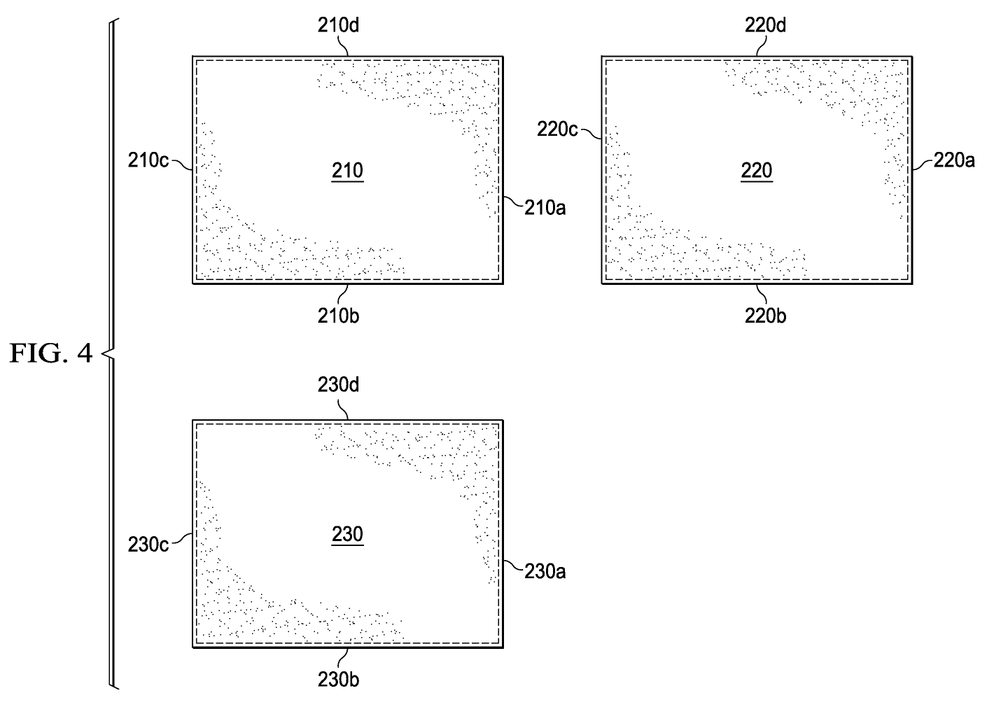

FIG. 4 illustrates items of hand pillow 200 in this embodiment, with different layers:
Layer 210
Layer 220
Layer 230
   Hand pillow 200 is comprised of layers 210, 220, and 230, each of which have substantially the same dimensions along their widths and lengths, as illustrated in FIG. 4. In addition, in this embodiment, layer 210 has four sides or edges (210a, 210b, 210c and 210d), layer 220 has four sides or edges (220a, 220b, 220c and 220d), and layer 230 has four sides or edges (230a, 230b, 230c and 230d). Each of the layers 210, 220, and 230 having four sides is merely illustrative, and thus layers have any number of sides, no sides per se such as with round- or elliptical-shaped hand pillows, or even pillows substantially shaped like the outline of a user's hand, are also envisioned and fall within the scope of the present disclosure.

A fill material such as polyester, down, or feathers may be placed between layers 210 and 220 or between layers 220 and 230. A manufacturer may also choose to use a pillow insert in which case the pillow insert would be placed between layers 210 and 220 or between layers 220 and 230. Pillow 200 may have one insert/filled material since it is comprised of three layers whereas pillow 100 may have one or two inserts/filled materials since it is comprised of four layers.

FIG. 4 illustrates the individual layers 210, 220, and 230, and the exemplary areas of attachment. The “X” represents the area of attachment. FIG. 4 shows the areas of attachment substantially along certain edges of the pillow 200. Specifically, sides 210a, 220a, and 230a are attached together. Sides 210b and 220b are attached together. Sides 210c, 220c, and 230c are attached together. Sides 210d, 220d, and 230d are attached together. Attaching the layers as described above creates a pocket 250 for a user's hand to be inserted therein.

A fill material such as polyester, down, or feathers may be placed between layers 210 and 220. The amount of fill material can be determined by the manufacturer. A manufacturer may also choose to have a pre-made pillow of the correct size and dimensions inserted between layers 210 and 220.

Like hand pillow 100, the person inserts his or her hand into the pocket 250 of pillow 200 that is created along edges 210b, 220b, and 230b. The palm of the person's hand is substantially in contact with the bottom side of layer 220. The person's face would be substantially in contact with the top side of layer 210.

The attached edges substantially prevent the pocket hand pillow 200 from sliding off the person's hand. The preferable method of attachment along the applicable edges is sewing, although other methods to secure the layers together could also be used. A traditional pillow does not have a pocket and may slide off of its resting location when the person is resting.

Since pocket hand pillow 200 is comprised of three layers, it may be less expensive to manufacture than pocket hand pillow 100.

Of course, the above description of the embodiment illustrated in FIG. 3 is illustrative only, and variations to the above-described approach may also be included in a hand pillow constructed according to the disclosed principles.

The physical dimensions of the layers and method of attachment are for illustrative purposes only. The embodiments in the present disclosure illustrate 4-sided polygon layers and resulting pillows. However, one may also choose to use other multi-sided polygon, elliptical, or circular layers, or even layers substantially shaped like the outline of a user's hand, to construct pillow of corresponding shape. Also, the method of attaching the layers and area of attachment can be determined by the designer or manufacturer. Although we have shown three layers or four layers in our illustrations, a hand pillow constructed in accordance with the present disclosure should be comprised of at least three or more layers. The material of the hand pillow, dimensions, spacing, and the fill material of the hand pillow, can be determined by the designer or manufacturer.

Each layer of hand pillow 100 and 200 may be comprised of different materials or thicknesses. Hand pillows 100 and 200 may have layers comprised of various thicknesses of cotton, fur or faux fur. The fill material (polyester, feathers, down, etc.) which determines the softness or firmness of the pillow can be decided by the manufacturer.

In U.S. Pat. No. 4,375,809, Meals describes an inflatable hand pillow used to elevate the hand during a healing period. Meals pillow has inflatable chambers and cushions for the arm and forearm. The disclosed hand pillow has no inflatable chambers and is intended to enclose a substantial portion of the hand and not the arm or forearm.

In U.S. Pat. No. 6,526,612, Zarella claims a pillow comprised of a cushion which rests in the palm of the user and a strap used to affix the pillow to the hand. The disclosed hand pillow uses no straps to secure the pillow to the hand. Instead the disclosed hand pillow forms a pocket into which the hand is inserted thereby keeping the pillow on the hand. In an alternate embodiment, Zarella also claims a pillow comprised of a cushion which rests in the palm of the user and sheaths which in which one or more fingers is inserted. The disclosed hand pillow uses a pocket instead of a sheath to hold the pillow on the hand of the user. The Zarella pillow is open at both ends while the disclosed hand pillow is open only at one end. The Zarella pillow is intended to provide cushion for just the palm of the user while the disclosed hand pillow offers cushion for the entire hand.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A pillow having a pocket, comprising:
a first side of said pillow, comprising a first outer layer and a first inner layer, and having a first filling material located between the first outer and inner layers;
a second side of said pillow, comprising a second outer layer and a second inner layer, and having a second filling material located between the second outer and inner layers; and
wherein said first side and said second side are attached to each other along at least a portion of their corresponding edges to create a pocket between the first and second sides.

2. A pillow according to claim 1, wherein the second side is coextensive along its length and width with the first side.

3. A pillow according to claim 1, wherein the first and second sides are rectilinear, and wherein the first and second sides are attached along three of their corresponding edges.

4. A pillow according to claim 1, wherein at least one of the first or second outer layers is constructed from a material selected from the group consisting of cotton, fur or faux fur.

5. A pillow according to claim 1, wherein at least one of the first or second filling material is selected from the group consisting of polyester, down, or feathers.

6. A pillow according to claim 1, wherein said first side and second side are attached to each other along a least a portion of their corresponding edges using sewing.

7. A pillow having a pocket, comprising:
a first side of said pillow, comprising a first outer layer and a first inner layer, and having a first filling material located between the first outer and inner layers;
a second side of said pillow; and
wherein said first side and said second side are attached to each other along at least a portion of their corresponding edges to create a pocket between the first and second sides.

8. A pillow according to claim 7, wherein the second side is coextensive along its length and width with the first side.

9. A pillow according to claim 7, wherein the first and second sides are rectilinear, and wherein the first and second sides are attached along three of their corresponding edges.

10. A pillow according to claim 7, wherein at least one of the first or second outer layers is constructed from a material selected from the group consisting of cotton, fur or faux fur.

11. A pillow according to claim 7, wherein the first filling material is selected from the group consisting of polyester, down, or feathers.

12. A pillow according to claim 7, wherein said first side and second side are attached to each other along a least a portion of their corresponding edges using sewing.

13. A pillow according to claim 7, wherein the second side comprises a second inner layer and a second outer layer, each constructed of a different material.

14. A method of manufacturing a pillow having a pocket, said method comprising:
combining a first outer layer and a first inner layer, and having a first filling material located between the first outer and inner layers, to create a first side of said pillow;
providing a second side of said pillow; and
creating a pocket between the first and second sides by attaching said first side and said second side along at least a portion of their corresponding edges.

15. A method according to claim 14, wherein the second side is coextensive along its length and width with the first side.

16. A method according to claim 14, wherein the first and second sides are rectilinear, and wherein the first and second sides are attached along three of their corresponding edges.

17. A method according to claim 14, wherein at least one of the first or second outer layers is constructed from a material selected from the group consisting of cotton, fur or faux fur.

18. A method according to claim 14, wherein the first filling material is selected from the group consisting of polyester, down, or feathers.

19. A method according to claim 14, wherein attaching said first side and second side to each other along a least a portion of their corresponding edges further comprising using sewing.

20. A method according to claim 14, wherein providing the second side further comprises combining a second outer layer and a second inner layer, each constructed of a different material, and having a second filling material located between the second outer and second inner layers, to create said second side.
